(19) United States
(12) Patent Application Publication
(10) Pub. No.: US 2021/0094816 A1
(43) Pub. Date: Apr. 1, 2021

(54) BEVERAGE SUPPLYING APPARATUS

(71) Applicant: FUJI ELECTRIC CO., LTD., Kawasaki-shi (JP)

(72) Inventors: Yuuki TOKUNAGA, Yokkaichi-city (JP); Shunsuke KOWASE, Yokkaichi-city (JP)

(73) Assignee: FUJI ELECTRIC CO., LTD., Kawasaki-shi (JP)

(21) Appl. No.: 17/121,135

(22) Filed: Dec. 14, 2020

Related U.S. Application Data
(63) Continuation of application No. PCT/JP2019/018978, filed on May 13, 2019.

(30) Foreign Application Priority Data
Jul. 4, 2018 (JP) 2018-127288
Nov. 30, 2018 (JP) 2018-224664

(51) Int. Cl. B67D 1/12; G07F 13/06; B67D 1/08

(52) U.S. Cl. CPC B67D 1/124; G07F 13/065; B67D 2210/00065; B67D 2210/00041; B67D 1/0888

(57) ABSTRACT

A beverage supplying apparatus having a beverage supplying unit, for making a beverage and supplying the beverage into a container placed in the beverage supplying unit. The beverage supplying apparatus includes a supply instruction button configured to be pressable for giving an instruction for making and supplying the beverage, a presenting operation unit configured to present a plurality of pieces of information and to receive an operation, and a control unit. The control unit is configured to, responsive to a pressing operation of the supply instruction button, cause the presenting operation unit to present a message for placing the container in the beverage supplying unit, and to present an input unit for confirming that the container has been placed in the beverage supplying unit, and responsive to receipt of the operation by the presenting operation unit after presenting the input unit, control the beverage supplying apparatus to dispense the beverage into the container.

### CROSS-REFERENCE TO RELATED APPLICATION(S)

This application is a continuation of International Application No. PCT/JP2019/018978, filed on May 13, 2019 which claims the benefit of priority of the prior Japanese Patent Application Nos. 2018-127288, filed on Jul. 4, 2018, and 2018-224664, filed on Nov. 30, 2018, the entire contents of which are incorporated herein by reference.

### BACKGROUND

The present disclosure relates to a beverage supplying apparatus.

In the related art, beverage supplying apparatuses such as coffee machines have been installed, for example, in stores such as convenience stores. A beverage supplying apparatus is an apparatus that makes a beverage by performing processes such as grinding of coffee beans and extraction through dripping, and supplies the beverage into a container such as a cup.

Such a beverage supplying apparatus supplies a beverage into a container when a pressing operation of a supply instruction button for giving an instruction for making and supplying a beverage is performed (for example, see Japanese Laid-open Patent Publication No. 2015-29544).

### SUMMARY

There is a need for providing a beverage supplying apparatus capable of reducing the chances of a beverage being supplied without a container disposed in the beverage supplying unit.

According to an embodiment, a beverage supplying apparatus that supplies a beverage made in a beverage maker unit into a container placed in a beverage supplying unit, includes: a supply instruction button for giving an instruction for making and supplying a beverage; a presenting operation unit that presents a message in response to a given instruction, and that is enabled to receive an operation; and a control unit that is triggered, by a pressing operation of the supply instruction button, to cause the presenting operation unit to present a message to place a container in the beverage supplying unit, and to present an input unit used for making a confirmation that the container has been placed in the beverage supplying unit, and that supplies, when an operation of the input unit is performed, the beverage made in the beverage maker unit into the container.

According to an embodiment, a beverage supplying apparatus that supplies a beverage made in a beverage maker unit into a container placed in a beverage supplying unit, includes: a container detecting unit that detects that the container has been placed in the beverage supplying unit; a supply instruction button for giving an instruction for making and supplying a beverage; and a control unit that activates the supply instruction button when the container detecting unit detects that the container has been placed, and deactivates the supply instruction button when the container detecting unit does not detect that the container has been placed. Further, when a pressing operation of the activated supply instruction button is performed, the control unit supplies the beverage made in the beverage maker unit into the container.

### BRIEF DESCRIPTION OF DRAWINGS

FIG. 1 is a perspective view illustrating an external structure of a beverage supplying apparatus according to a first embodiment of the present disclosure;

FIG. 2 is a block diagram schematically illustrating a control system of the beverage supplying apparatus according to the first embodiment of the present disclosure;

FIG. 3 is a flowchart illustrating the sequence of a process performed by the control unit illustrated in FIG. 2;

FIG. 4 illustrates parts (a) to (c) that are explanatory schematic examples of messages presented by a presenting operation unit;

FIG. 5 is a perspective view illustrating an external structure of a beverage supplying apparatus according to a second embodiment of the present disclosure;

FIG. 6 is a block diagram schematically illustrating a control system of the beverage supplying apparatus according to the second embodiment of the present disclosure;

FIG. 7 is a flowchart illustrating the sequence of a process performed by the control unit illustrated in FIG. 6;

FIG. 8 is a perspective view illustrating an external structure of a beverage supplying apparatus according to a third embodiment of the present disclosure;

FIG. 9 is a block diagram schematically illustrating a control system of a beverage supplying apparatus according to the third embodiment of the present disclosure;

FIG. 10 is a flowchart illustrating the sequence of a process performed by the control unit illustrated in FIG. 9; and

FIG. 11 illustrates parts (a) to (e) that are explanatory schematic examples of messages presented by a presenting operation unit.

### DETAILED DESCRIPTION

In the beverage supplying apparatus described above, a beverage is supplied when a pressing operation of the supply instruction button is performed. Therefore, if the pressing operation of the supply instruction button is performed without a user placing a container in a designated beverage supplying unit, there is a chance that the made beverage is discharged without being supplied into a container. The beverage being discharged in the manner described above is not preferable not only because the user suffers a disadvantage, but also because the made beverage is wasted.

Some preferred embodiments of a beverage supplying apparatus according to the present disclosure will now be explained in detail with reference to the accompanying drawings.

### First Embodiment

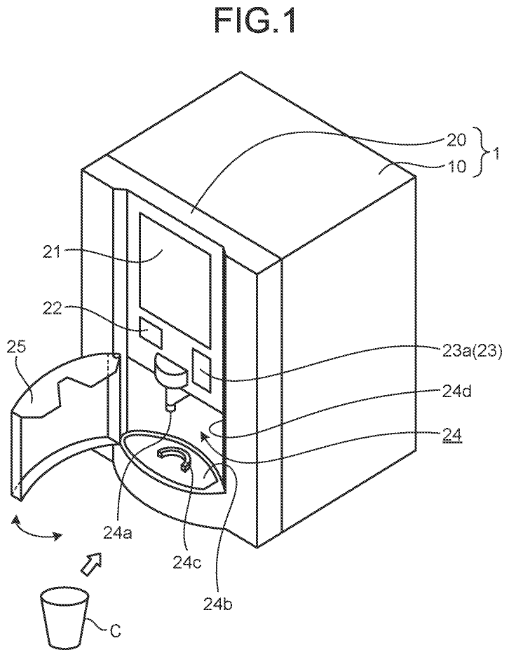

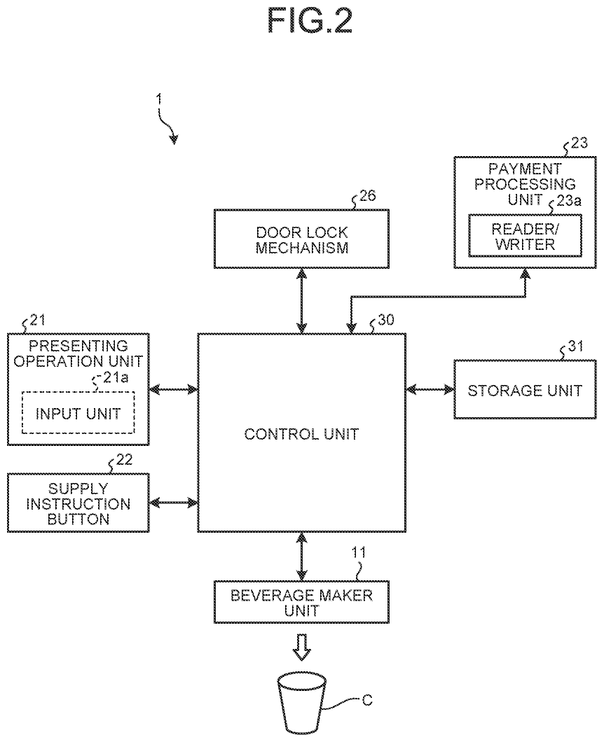

FIGS. 1 and 2 illustrate a beverage supplying apparatus according to a first embodiment of the present disclosure. FIG. 1 is a perspective view illustrating an external structure, and FIG. 2 is a block diagram schematically illustrating a control system. A beverage supplying apparatus 1 explained herein as an example is a coffee machine installed in a store such as a convenience store, and is an apparatus that grinds coffee beans, performs an extracting process through dripping, and supplies a beverage such as coffee into a container C such as a cup, for example. The apparatus main body 1 includes a main body cabinet 10 and a front door 20.

The main body cabinet 10 has a substantially cuboid shape with an opening on the front side. A beverage maker unit 11 for making a beverage (such as coffee) is provided inside the main body cabinet 10.

The front door 20 is a door body having a size enough to close the front opening of the main body cabinet 10. This front door 20 is provided in a swingable manner about the central axis of a shaft, not illustrated, extending in the up-and-down direction, along a front side edge of the main body cabinet 10, and is capable of opening and closing the front opening of the main body cabinet 10.

The front door 20 has a customer-service surface on the front side, and includes a presenting operation unit 21, a supply instruction button 22, a payment processing unit 23, a beverage supplying unit 24, and a door 25.

The presenting operation unit 21 is provided with a liquid crystal touch panel, for example, presents various types of information, and includes an input unit 21a allowing operation inputs such as touch operations to be made. The supply instruction button 22 is an input unit for giving an instruction for making and supplying a beverage. The supply instruction button 22 may also be a GUI button presented by the presenting operation unit 21.

The payment processing unit 23 is configured to perform payment processing such as that via electronic money, for example, and is provided with a reader/writer 23a that exchanges data with a mobile information terminal, such as a smartphone.

The beverage supplying unit 24 is provided under the presenting operation unit 21, and includes a nozzle 24a and a stage 24b. The nozzle 24a discharges a beverage made in the beverage maker unit 11 downwards. The stage 24b is provided to an area below the nozzle 24a. This stage 24b is where the container C is placed, and is provided with an arch-shaped stopper 24c.

The door 25 is made of a translucent material such as a transparent resin, for example, and has a size enough to cover an entrance 24d of the beverage supplying unit 24. The door 25 has its left end pivotally supported on the front door 20, and is swingable in the front-back direction. In other words, the door 25 is swingable in the front-back direction in a manner moving closer to and away from the beverage supplying unit 24. The door 25 can close the entrance 24d of the beverage supplying unit 24 by being swung rearwards in a manner moving closer to the beverage supplying unit 24, and open the entrance 24d of the beverage supplying unit 24 by being swung frontwards in a manner moving away from the beverage supplying unit 24.

As illustrated in FIG. 2, the beverage supplying apparatus 1 includes a door lock mechanism 26 and a control unit 30. The door lock mechanism 26 is provided near the entrance 24d of the beverage supplying unit 24. This door lock mechanism 26 can be alternatingly switched between a locked condition where the door 25 for closing the entrance 24d is kept closed to restrict the forward swinging movement of the door 25 and an unlocked condition where the door 25 is allowed to swing forwards. The switching of such a door lock mechanism 26 is done based on an instruction given by the control unit 30.

The control unit 30 is electrically connected to the beverage maker unit 11, the presenting operation unit 21, the supply instruction button 22, the payment processing unit 23, and the door lock mechanism 26 described above, and controls the operations of these units comprehensively in accordance with a computer program and data stored in a storage unit 31 that is also electrically connected. The control unit 30 may be implemented by causing a processor such as a central processing unit (CPU) to execute a computer program, that is, implemented in software in hardware, or implemented in hardware such as an integrated circuit (IC). The control unit 30 may also be implemented in software and hardware.

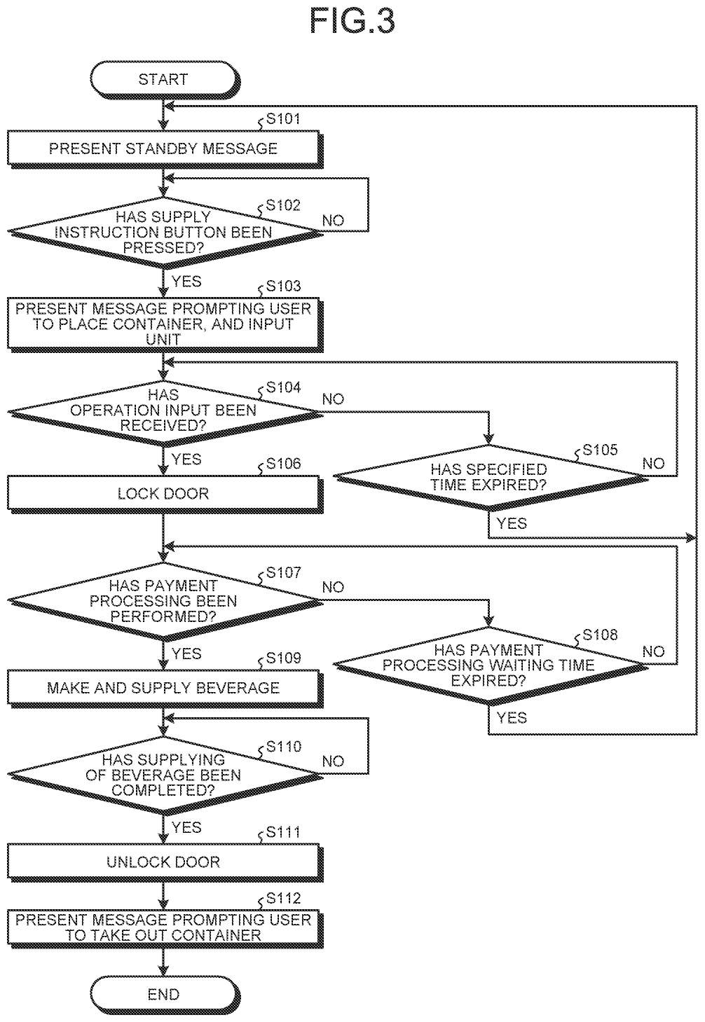

FIG. 3 is a flowchart illustrating the sequence of a process performed by the control unit 30 illustrated in FIG. 2. An operation of the beverage supplying apparatus 1 will also be explained, while explaining the details of the beverage supply control process.

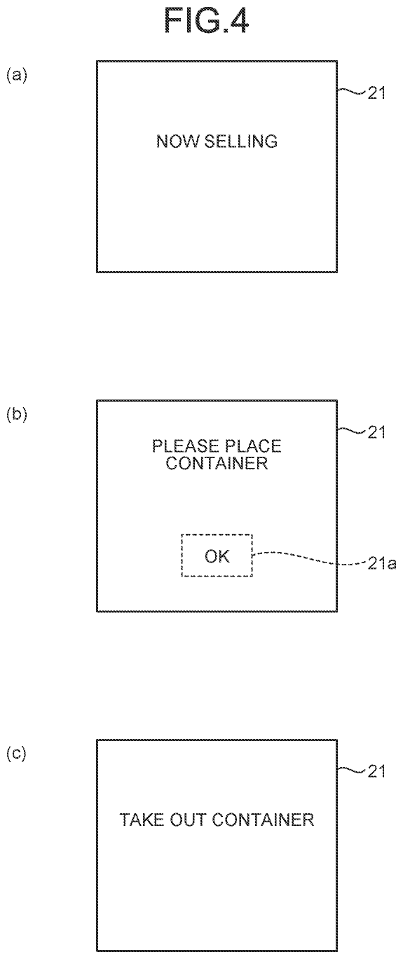

As indicated in part (a) in FIG. 4, the control unit 30 causes the presenting operation unit 21 to present a standby message indicating “Now selling”, for example (Step S101), and waits for a pressing operation of the supply instruction button 22 (Step S102).

If a pressing operation of the supply instruction button 22 is performed (Yes at Step S102), the control unit 30 causes the presenting operation unit 21 to present a message prompting a user to place the container C in the beverage supplying unit 24, and to present an input unit 21a used for making a confirmation that the container C has been placed in the beverage supplying unit 24 (Step S103). In other words, as indicated in part (b) in FIG. 4, the presenting operation unit 21 presents a message indicating “Place container” and an input unit 21a indicating “OK”, at the same time. The control unit 30 then determines whether an operation input of the input unit 21a is received before a preset set time expires from when the process at Step S103 is performed (Step S104, Step S105).

If the set time expires without receiving any operation input (No at Step S104, Yes at Step S105), the control unit 30 goes back to the process at Step S101, and causes the presenting operation unit 21 to present the standby message.

If an operation input is received before the set time expires (Yes at Step S104, No at Step S105), the control unit 30 locks the door 25 closed using the door lock mechanism 26 (Step S106), and determines whether the payment processing unit 23 has performed the payment processing before a preset payment processing waiting time expires from when the process at Step S106 is performed (Step S107, Step S108).

If the payment processing waiting time expires without the payment processing being performed by the payment processing unit 23 (No at Step S107, Yes at Step S108), the control unit 30 causes the door lock mechanism 26 to unlock the closed door 25, goes back to the process at Step S101, and causes the presenting operation unit 21 to present the standby message.

If the payment processing unit 23 has performed the payment processing before the payment processing waiting time expires (Yes at Step S107, No at Step S108), the control unit 30 causes the beverage maker unit 11 to perform the process of making and supplying the beverage to be supplied (Step S109).

The control unit 30 then determines whether the beverage maker unit 11 has completed supplying the beverage (Step S110). If the supplying of the beverage has not been completed (No at Step S110), the control unit 30 goes back to Step S109, and continues the process of making and supplying the beverage. If the supplying of the beverage has been completed (Yes at Step S110), the control unit 30 causes the door lock mechanism 26 to unlock the closed door 25 (Step S111), presents a message prompting the user to take out the container C, for example, “Take out container”, as indicated in part (c) in FIG. 4 (Step S112), and ends the current process.

As explained above, with the beverage supplying apparatus 1 according to the first embodiment of the present disclosure, a pressing operation of the supply instruction button 22 triggers the control unit 30: to cause the presenting operation unit 21 to present a message prompting a user to place a container C in the beverage supplying unit 24 and present an input unit 21a a confirmation that the container C has been placed in the beverage supplying unit 24, and to cause the beverage made in the beverage maker unit 11 to be supplied into the container C when an operation input of the input unit 21a is received. Thus, not only is it possible to prompt a user to place the container C in the beverage supplying unit 24, but it also allows the user to clearly recognize that the container C has been placed, by causing the user to make an input operation to the input unit 21a. Therefore, it is possible to reduce the chances of a beverage being supplied without a container C placed in the beverage supplying unit 24.

In the example described in the first embodiment, the door 25 for opening and closing the entrance 24d of the beverage supplying unit 24 is provided, but according to the present disclosure, it is possible for the door 25 not to be provided. In such a case, in the process illustrated in FIG. 3, the processes at Step S106 and Step S111 are omitted.

### Second Embodiment

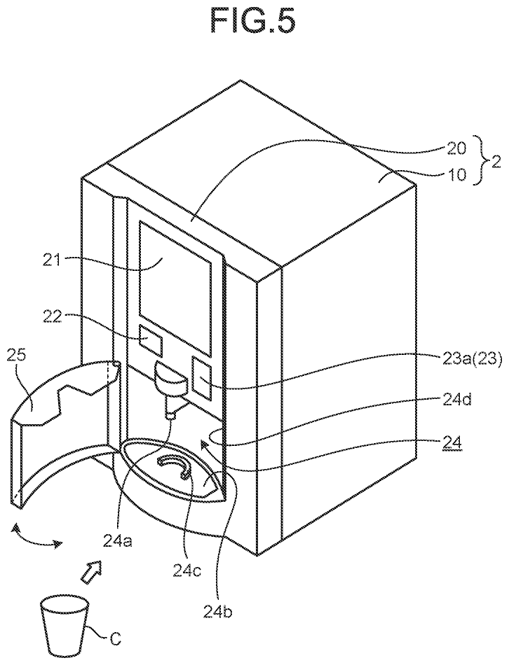

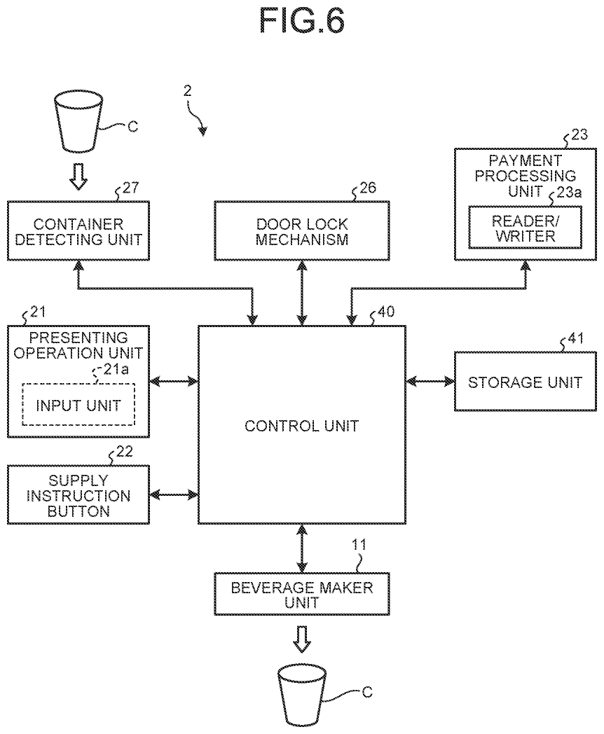

FIGS. 5 and 6 illustrate a beverage supplying apparatus according to a second embodiment of the present disclosure. FIG. 5 is a perspective view illustrating an external structure, and FIG. 6 is a block diagram schematically illustrating a control system. Elements that are the same as those in the first embodiment are given the same reference signs, and explanations thereof will be omitted as appropriate.

A beverage supplying apparatus 2 explained herein as an example is a coffee machine installed in a store such as a convenience store, and is an apparatus that grinds coffee beans, performs an extracting process through dripping, and supplies a beverage such as coffee into a container C such as a cup, for example. The apparatus main body 2 includes a main body cabinet 10 and a front door 20.

The main body cabinet 10 has a substantially cuboid shape with an opening on the front side. A beverage maker unit 11 for making a beverage (such as coffee) is provided inside the main body cabinet 10.

The front door 20 is a door body having a size enough to close the front opening of the main body cabinet 10. This front door 20 is provided in a swingable manner about the central axis of a shaft, not illustrated, extending in the up-and-down direction, along a front side edge of the main body cabinet 10, and is capable of opening and closing the front opening of the main body cabinet 10.

The front door 20 has a customer-service surface on the front side, and includes the presenting operation unit 21, the supply instruction button 22, the payment processing unit 23, the beverage supplying unit 24, and the door 25.

The presenting operation unit 21 is provided with a liquid crystal touch panel, for example, presents various types of information, and includes the input unit 21a allowing operation inputs such as touch operations to be made. The supply instruction button 22 is an input unit for giving an instruction for making and supplying a beverage. The supply instruction button 22 may also be a GUI button presented by the presenting operation unit 21.

The payment processing unit 23 is configured to perform payment processing such as that via electronic money, for example, and is provided with the reader/writer 23a that exchanges data with a mobile information terminal, such as a smartphone.

The beverage supplying unit 24 is provided under the presenting operation unit 21, and includes a nozzle 24a and a stage 24b. The nozzle 24a discharges a beverage made in the beverage maker unit 11 downwards. The stage 24b is provided to an area below the nozzle 24a. This stage 24b is where the container C is placed, and is provided with an arch-shaped stopper 24c.

The door 25 is made of a translucent material such as a transparent resin, and has a size enough to cover an entrance 24d of the beverage supplying unit 24, for example. Such a door 25 has its left end pivotally supported on the front door 20, and is swingable in the front-back direction. In other words, the door 25 is swingable in the front-back direction in a manner moving closer to and away from the beverage supplying unit 24. The door 25 can close the entrance 24d of the beverage supplying unit 24 by being swung rearwards in a manner moving closer to the beverage supplying unit 24, and open the entrance 24d of the beverage supplying unit 24 by being swung frontwards in a manner moving away from the beverage supplying unit 24.

As illustrated in FIG. 6, the beverage supplying apparatus 2 includes a door lock mechanism 26, a container detecting unit 27, and a control unit 40.

The container detecting unit 27 includes an optical sensor, for example, and detects whether the container C is disposed in the beverage supplying unit 24, more specifically, whether the container C has been placed on the stage 24b. The container detecting unit 27 feeds the result of detecting the presence of the container C to the control unit 40.

The control unit 40 is electrically connected to the beverage maker unit 11, the presenting operation unit 21, the supply instruction button 22, the payment processing unit 23, the container detecting unit 27, and the door lock mechanism 26 described above, and controls the operations of these units comprehensively in accordance with a computer program and data stored in a storage unit 41 that is also electrically connected. The control unit 40 may be implemented by causing a processor such as a central processing unit (CPU) to execute a computer program, that is, implemented in software, or implemented in hardware such as an integrated circuit (IC). The control unit 40 may also be implemented in software and hardware.

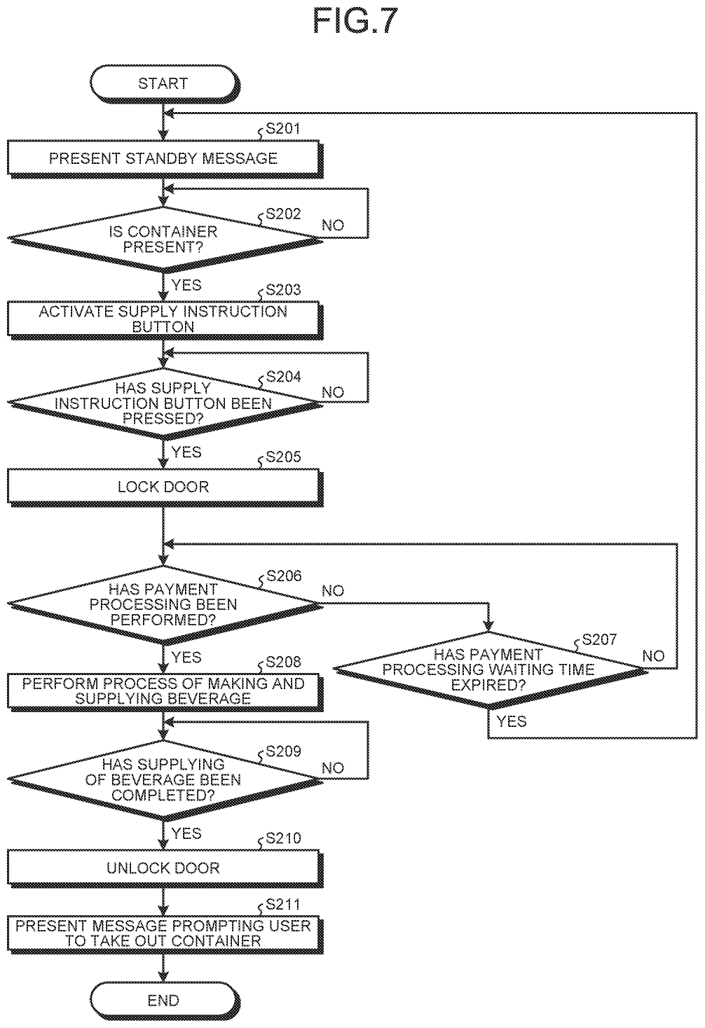

FIG. 7 is a flowchart illustrating the sequence of a process performed by the control unit 40 illustrated in FIG. 6. An operation of the beverage supplying apparatus 2 will also be explained, while explaining the details of the process.

The control unit 40 causes the presenting operation unit 21 to present a standby message such as “Now selling” (Step S201), and determines whether the container detecting unit 27 has detected the presence of the container C in the beverage supplying unit 24 (Step S202). In other words, the container detecting unit 27 detects whether the container C has been placed on the stage 24b.

If the presence of the container C is detected (Yes at Step S202), the control unit 40 activates the supply instruction button 22, that is, makes the supply instruction button 22 available for a pressing operation (Step S203), and waits for a pressing operation of the supply instruction button 22 (Step S204). If the presence of the container C is not detected (No at Step S202), the control unit 40 repeats the determination process at Step S202. In this case, the control unit 40 deactivates the supply instruction button 22, that is, makes the supply instruction button 22 unavailable for a pressing operation.

If a pressing operation of the supply instruction button 22 is performed (Yes at Step S204), the control unit 40 locks the door 25 closed using the door lock mechanism 26 (Step S205), and determines whether the payment processing unit 23 has performed the payment processing before the preset payment processing waiting time expires from when the process at Step S205 is performed (Step S206, Step S207).

If the payment processing waiting time expires without the payment processing being performed by the payment processing unit 23 (No at Step S206, Yes at Step S207), the control unit 40 causes the door lock mechanism 26 to unlock the closed door 25, goes back to the process at Step S201, and causes the presenting operation unit 21 to present the standby message.

If the payment processing unit 23 has performed the payment processing before the payment processing waiting time expires (Yes at Step S206, No at Step S207), the control unit 40 causes the beverage maker unit 11 to perform the process of making and supplying the beverage to be supplied (Step S208).

The control unit 40 then determines whether the beverage maker unit 11 has completed supplying the beverage (Step S209). If the supplying of the beverage has not been completed (No at Step S209), the control unit 40 goes back to Step S208, and continues the process of making and supplying the beverage. If supplying of the beverage has been completed (Yes at Step S209), the control unit 40 causes the door lock mechanism 26 to unlock the closed door 25 (Step S210), presents a message prompting the user to take out the container C, e.g., “Take out container” (Step S211), and then ends the current process.

As explained above, with the beverage supplying apparatus 2 according to the second embodiment of the present disclosure, when the container detecting unit 27 detects that the container C has been placed, the control unit 40 activates the supply instruction button 22, and, when a pressing operation of the activated supply instruction button 22 is performed, the beverage made in the beverage maker unit 11 is supplied into the container C. Therefore, it is possible to reduce the chances of the beverage being supplied without a container C placed in the beverage supplying unit 24.

In the example described in the second embodiment, the door 25 for opening and closing the entrance 24d of the beverage supplying unit 24 is provided, but according to the present disclosure, it is possible for the door 25 not to be provided. In such a case, in the process illustrated in FIG. 7, the processes at Step S205 and Step S210 are omitted.

### Third Embodiment

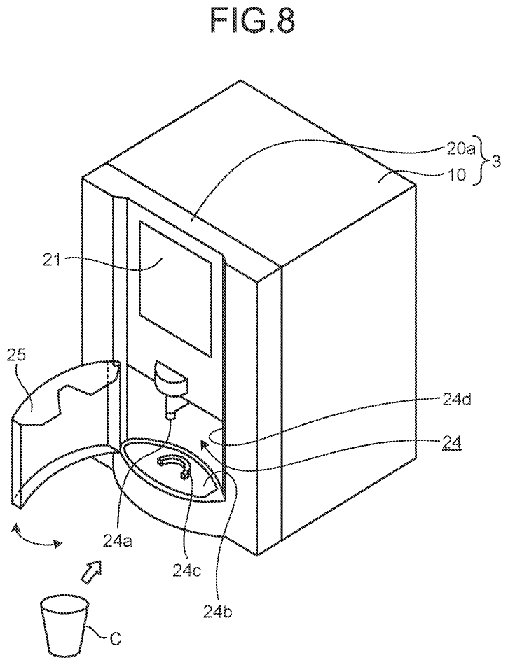

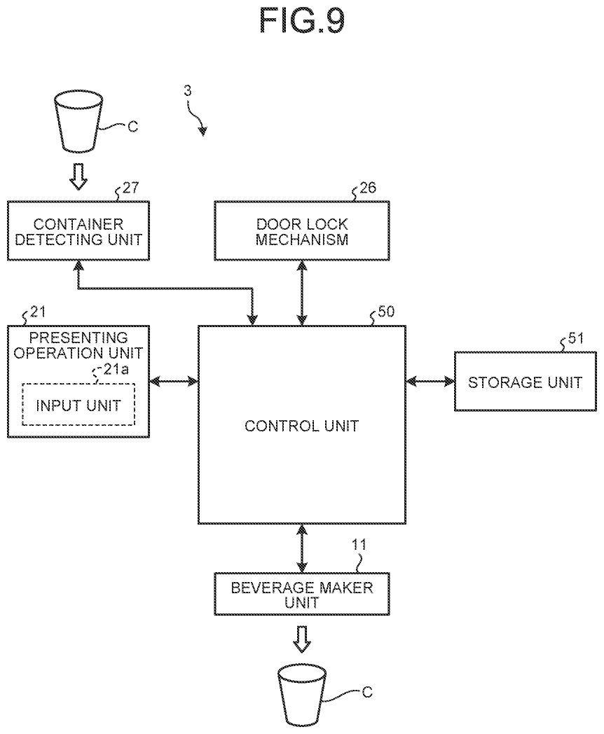

FIGS. 8 and 9 illustrate a beverage supplying apparatus according to a third embodiment of the present disclosure. FIG. 8 is a perspective view illustrating an external structure, and FIG. 9 is a block diagram schematically illustrating a control system. Elements that are the same as those in the first embodiment are given the same reference signs, and explanations thereof will be omitted as appropriate.

A beverage supplying apparatus 3 explained herein as an example is a coffee machine installed in a store such as a convenience store, for example, and is an apparatus that grinds coffee beans, performs an extracting process through dripping, and supplies a beverage such as coffee into a container C such as a cup, for example. Such a beverage supplying apparatus 3 is provided with the main body cabinet 10 and a front door 20a.

The main body cabinet 10 has a substantially cuboid shape with an opening on the front side. A beverage maker unit 11 for making a beverage (such as coffee) is provided inside of the main body cabinet 10.

The front door 20a is a door body having a size enough to close the front opening of the main body cabinet 10. This front door 20a is provided in a swingable manner about the central axis of a shaft, not illustrated, extending in the up-and-down direction, along a front side edge of the main body cabinet 10, and is capable of opening and closing the front opening of the main body cabinet 10.

Such a front door 20a has a customer-service surface on the front side, and includes the presenting operation unit 21, the beverage supplying unit 24, and the door 25.

The presenting operation unit 21 is provided with a liquid crystal touch panel, for example, presents various types of information, and includes the input unit 21a allowing operation inputs such as touch operations to be made. This input unit 21a also functions as a supply instruction button for giving an instruction for making and supplying a beverage.

The beverage supplying unit 24 is provided under the presenting operation unit 21, and includes the nozzle 24a and the stage 24b. The nozzle 24a discharges the beverage made in the beverage maker unit 11 downwards. The stage 24b is provided to the area below the nozzle 24a. This stage 24b is where the container C is placed, and is provided with an arch-shaped stopper 24c.

The door 25 is made of a translucent material such as a transparent resin, for example, and has a size enough to cover an entrance 24d of the beverage supplying unit 24, for example. This door 25 has its left end pivotally supported on the front door 20a, and is swingable in the front-back direction. In other words, the door 25 is swingable in the front-back direction in a manner moving closer to and away from the beverage supplying unit 24. The door 25 can close the entrance 24d of the beverage supplying unit 24 by being swung rearwards in a manner moving closer to the beverage supplying unit 24, and open the entrance 24d of the beverage supplying unit 24 by being swung frontwards in a manner moving away from the beverage supplying unit 24.

As illustrated in FIG. 9, the beverage supplying apparatus 3 is provided with the door lock mechanism 26, the container detecting unit 27, and a control unit 50.

The container detecting unit 27 includes an optical sensor, for example, and detects whether the container C is disposed in the beverage supplying unit 24, more specifically, whether the container C has been placed on the stage 24b. This container detecting unit 27 feeds the result of detecting the presence of the container C to the control unit 50.

The control unit 50 is electrically connected to the beverage maker unit 11, the presenting operation unit 21, the container detecting unit 27, and the door lock mechanism 26 described above, and controls the operations of these units comprehensively in accordance with a computer program and data stored in a storage unit 51 that is also electrically connected. The control unit 50 may be implemented by causing a processor such as a central processing unit (CPU) to execute a computer program, that is, implemented in software, or implemented in hardware such as an integrated circuit (IC). The control unit 50 may also be implemented in software and hardware.

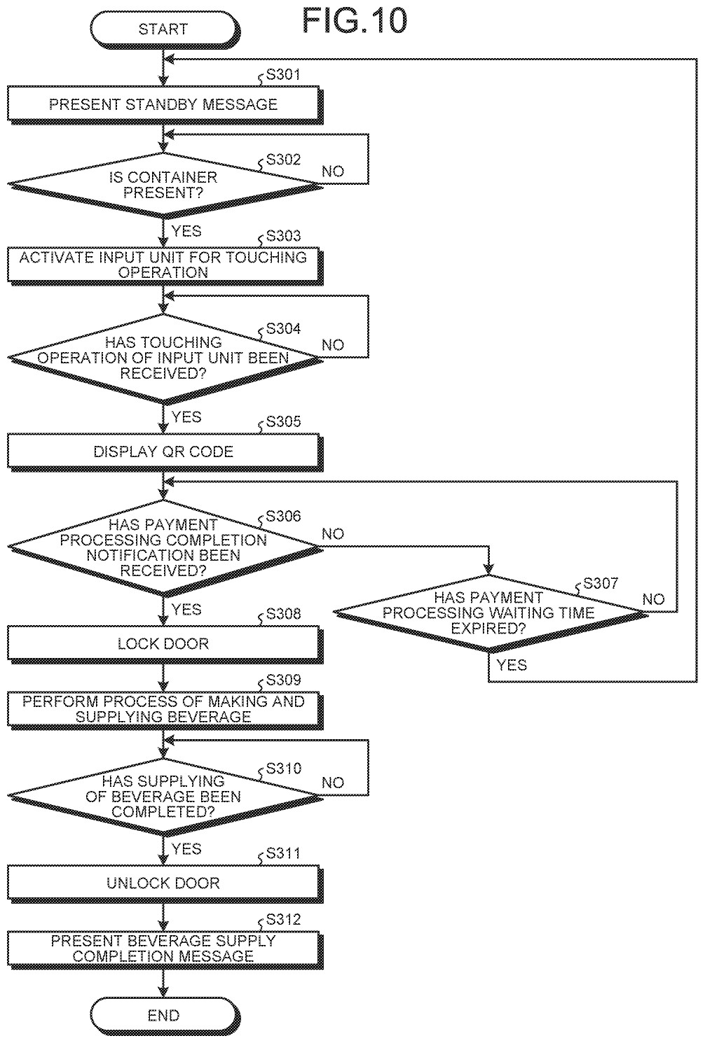

FIG. 10 is a flowchart illustrating the sequence of a process performed by the control unit 50 illustrated in FIG. 9. An operation of the beverage supplying apparatus 3 will be explained, while explaining the details of the beverage supply control process.

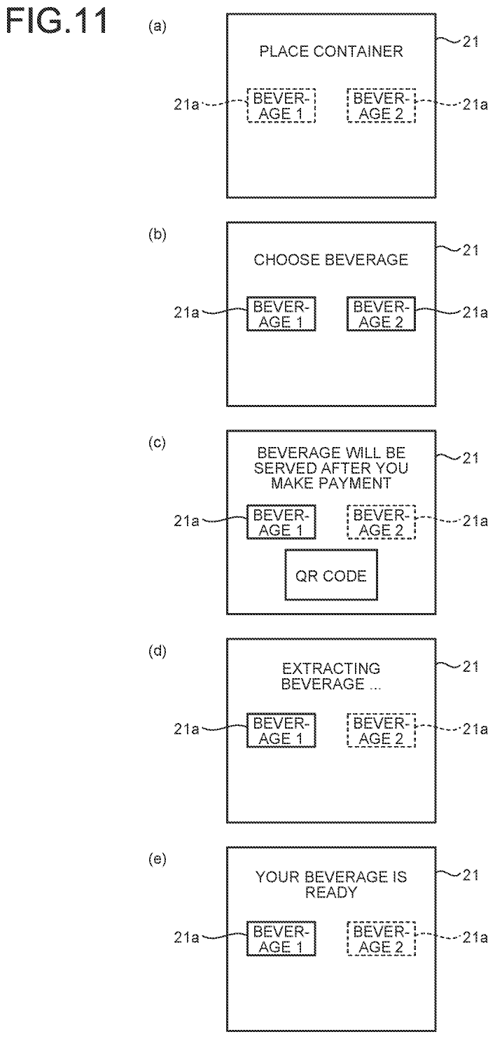

The control unit 50 causes the presenting operation unit 21 to present a message worded as “Place container”, and present a standby message via input units 21a for giving instructions for supplying “beverage 1” and “beverage 2”, at the same time, as illustrated in part (a) in FIG. 11 (Step S301), and determines whether the container detecting unit 27 has detected the presence of the container C in the beverage supplying unit 24 (Step S302). In other words, the container detecting unit 27 detects whether the container C has been placed on the stage 24b.

If the presence of the container C is detected (Yes at Step S302), the control unit 50 causes the presenting operation unit 21 to present a message worded as “Choose beverage”, and activates the input units 21a for giving supply instructions, that is, makes the input units 21a available for a touching operation (input operation) at the same time, as illustrated in part (b) in FIG. 11 (Step S303), and waits for a touching operation of the input units 21a (Step S304).

If the presence of the container C is not detected (No at Step S302), the control unit 50 repeats the determination process at Step S302. In this case, the control unit 50 deactivates the input units 21a for giving supply instructions, that is, makes the input units 21a unavailable for a touching operation.

If a touching operation of the input unit 21a is performed (Yes at Step S304), that is, if a touching operation of the input unit 21a corresponding to “beverage 1” is performed, for example, the control unit 50 causes the presenting operation unit 21 to present a QR code (registered trademark) for making the payment, while presenting a message worded as “Beverage will be served after you make payment”, as indicated in part (c) in FIG. 11 (Step S305).

The control unit 50 having presented the QR code (registered trademark) then determines whether a payment processing completion notification has been received via a predetermined communicating unit, before a preset payment processing waiting time expires from when the process at Step S305 is performed (Step S306, Step S307). Such a communicating unit is connected to a communication circuit such as a network, not illustrated, and is configured to transmit and to receive data.

By presenting a QR code (registered trademark) on the presenting operation unit 21, the user can read the QR code (registered trademark) using a mobile information terminal such as a smartphone, and performs the payment processing with a server responsible for the payment processing.

If the payment processing waiting time expires without receiving a payment processing completion notification, which indicates the proper completion of payment processing, from the mobile terminal device via the communicating unit (No at Step S306, Yes at Step S307), the control unit 50 goes back to the process at Step S301, and causes the presenting operation unit 21 to present the standby message.

If the payment processing completion notification, indicating that payment processing has been performed properly, is received from the mobile terminal device via the communicating unit before the payment processing waiting time expires (Yes at Step S306, No at Step S307), that is, if the predetermined payment processing is completed, the control unit 50 locks the door 25 closed, using the door lock mechanism 26 (Step S308).

The control unit 50 then causes the beverage maker unit 11 to perform the process of making and supplying the beverage to be supplied (Step S309), and to cause the presenting operation unit 21 to present a message worded as “Extracting beverage . . . ” as illustrated in part (d) in FIG. 11.

The control unit 50 then determines whether the beverage maker unit 11 has completed supplying the beverage (Step S310). If the supplying of the beverage has not been completed (No at Step S310), the control unit 50 goes back to Step S309, and continues the process of making and supplying the beverage.

If supplying of the beverage has been completed (Yes at Step S310), the control unit 50 causes the door lock mechanism 26 to unlock the closed door 25 (Step S311), and causes the presenting operation unit 21 to present a beverage supply completion message worded as “Your beverage is ready”, as indicated in part (e) in FIG. 11 (Step S312), and then ends the current process.

As explained above, with the beverage supplying apparatus 3 according to the third embodiment of the present disclosure, when the container detecting unit 27 detects that the container C has been placed, the control unit 50 activates the input unit 21a, and, when a touching operation of the activated input unit 21a is performed, the beverage made in the beverage maker unit 11 is supplied into the container C. Therefore, it is possible to reduce the chances of the beverage being supplied without a container C placed in the beverage supplying unit 24.

In the example described in the third embodiment, the door 25 for opening and closing the entrance 24d of the beverage supplying unit 24 is provided, but according to the present disclosure, it is possible for the door 25 not to be provided. In such a case, in the process illustrated in FIG. 10, the processes at Step S308 and Step S311 are omitted.

The first to the third preferred embodiments of the present disclosure are explained above, but the present disclosure is not limited thereto, and various modifications thereof are still possible.

Although not described in the first to the third embodiments, according to the present disclosure, a cancel button to cancel the payment processing may be provided. With such a cancel button provided, when a pressing operation of the cancel button is performed, it is possible to go back to the standby status. Therefore, it is not necessary for the user to wait for the expiry of the payment processing waiting time, so that the convenience can be improved.

In the first and the second embodiments described above, the payment processing unit 23 is provided as an element of the beverage supplying apparatus 1, 2, but it is also possible for the beverage supplying apparatus according to the present disclosure not to be provided with the payment processing unit 23.

In such a case, instead of performing Step S107, Step S206 illustrated in FIGS. 3 and 7, the beverage supplying apparatus may present a QR code (registered trademark) on the presenting operation unit, and determines whether a notification indicating that the payment processing has been performed properly between the mobile information terminal, such as a smartphone, having read the QR code (registered trademark) and the server responsible for the payment processing, has been received from the mobile information terminal. If it is determined that the notification indicating that the payment processing has been performed is received from the mobile information terminal, the process at Step S109, Step S208 may then be performed.

Although not described in the example in the third embodiment, in the present disclosure, it is also possible to provide a door sensor for detecting whether the entrance 24d of the beverage supplying unit 24 is open. When the door 25 is swung frontwards to open the entrance 24d, this door sensor is turned ON, and outputs the ON signal to the control unit 50. When the door 25 is swung backwards to close the entrance 24d, the door sensor is turned OFF and restricts the output of the ON signal. When such a door sensor is provided, it is preferable for the process at Step S303, which is performed when the presence of the container C is detected at Step S302, to be performed only when the door sensor has been turned OFF.

According to the present disclosure, the control unit is triggered, by a pressing operation of the supply instruction button, to cause the presenting operation unit to present a message prompting a user to place a container in the beverage supplying unit, and to present an input unit used for making a confirmation that the container has been placed in the beverage supplying unit, and, when an operation of the input unit is performed, the control unit supplies the beverage made in the beverage maker unit into the container. Therefore, not only is it possible to prompt a user to place a container in the beverage supplying unit, but it also allows the user to clearly recognize that the container has been placed, by causing the user to make an input operation to the input unit. As a result, this has the effect of being able to reduce the chances of a beverage being supplied without a container disposed in the beverage supplying unit.

Furthermore, according to the present disclosure, the control unit activates the supply instruction button when the container detecting unit detects that the container has been placed, and, when a pressing operation of the activated supply instruction button is performed, the beverage made in the beverage maker unit is supplied into the container. Therefore, it has the effect of being able to reduce the chances of a beverage being supplied without a container disposed in the beverage supplying unit.

Although the present disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A beverage supplying apparatus having a beverage supplying unit, for making a beverage and supplying the beverage into a container placed in the beverage supplying unit, the beverage supplying apparatus comprising:
a supply instruction button configured to be pressable for giving an instruction for making and supplying the beverage;
a presenting operation unit configured to present a plurality of pieces of information, and to receive an operation; and
a control unit that is configured to
responsive to a pressing operation of the supply instruction button, cause the presenting operation unit to present a message for placing the container in the beverage supplying unit, and to present an input unit for confirming that the container has been placed in the beverage supplying unit, and
responsive to receipt of the operation by the presenting operation unit after presenting the input unit, control the beverage supplying apparatus to dispense the beverage into the container.

2. The beverage supplying apparatus according to claim 1, wherein the control unit, responsive to the receipt of the operation by the presenting operation unit after presenting the input unit, controls the beverage supplying apparatus to dispense the beverage into the container, after confirming that predetermined payment processing has been completed.

3. The beverage supplying apparatus according to claim 1, further comprising:
a door that opens and closes an entrance of the beverage supplying unit; and
a door lock mechanism configured to cause the door to be alternately unopenable and openable, wherein
the control unit
responsive to the receipt of the operation by the presenting operation unit after presenting the input unit, controls the beverage supplying apparatus to dispense the beverage into the container, after confirming that the door is caused by the door lock mechanism to be unopenable and that predetermined payment processing has been completed, and
after the dispensing of the beverage, controls the door lock mechanism to cause the door to be openable.

4. A beverage supplying apparatus having a beverage supplying unit, for making a beverage and supplying the beverage into a container placed in the beverage supplying unit, the beverage supplying apparatus comprising:
a container detecting unit that detects whether the container has been placed in the beverage supplying unit;
a supply instruction button configured to be pressable for giving an instruction for making and supplying the beverage; and
a control unit that activates the supply instruction button when the container detecting unit detects that the container has been placed in the beverage supplying unit, and deactivates the supply instruction button when the container detecting unit detects that the container has not been placed in the beverage supplying unit, wherein
the control unit, responsive to a pressing operation of the activated supply instruction button, control the beverage supplying apparatus to dispense the beverage into the container.

5. The beverage supplying apparatus according to claim 4, wherein the control unit, responsive to the pressing operation of the activated supply instruction button, controls the beverage supplying apparatus to dispense the beverage into the container, after confirming that predetermined payment processing has been completed.

6. The beverage supplying apparatus according to claim 4, further comprising:
a door that opens and closes an entrance of the beverage supplying unit; and
a door lock mechanism configured to cause the door to be alternately unopenable and openable, wherein
the control unit
responsive to the pressing operation of the activated supply instruction button, controls the beverage supplying apparatus to dispense the beverage into the container, after confirming that the door is caused by the door lock mechanism to be unopenable and that predetermined payment processing has then been completed, and
after the dispensing of the beverage, controls the door lock mechanism to cause the door to be openable.

7. The beverage supplying apparatus according to claim 4, further comprising:
a door that opens and closes an entrance of the beverage supplying unit; and
a door lock mechanism configured to cause the door to be alternately unopenable and openable, wherein
the control unit
responsive to the pressing operation of the activated supply instruction button, controls the door lock mechanism to cause the door to be unopenable, and controls the beverage supplying apparatus to dispense the beverage into the container, after confirming that predetermined payment processing has been completed, and
after the dispensing of the beverage, controls the door lock mechanism to cause the door to be openable.

8. A beverage supplying apparatus having a beverage supplying unit, for making a beverage and supplying the beverage into a container placed in the beverage supplying unit, the beverage supplying apparatus comprising:
a supply instruction button configured to be pressable for giving an instruction for making and supplying the beverage;
a touchable display configured to display a plurality of pieces of information, and to receive an operation; and
a controller that is configured to
responsive to a pressing operation of the supply instruction button, cause the touchable display to display a message for placing the container in the beverage supplying unit, and to display an input information for confirming that the container has been placed in the beverage supplying unit, and
responsive to receipt of the operation by the touchable display after displaying the input information, control the beverage supplying apparatus to dispense the beverage into the container.

9. The beverage supplying apparatus of claim 8, wherein the controller is an integrated circuit.

10. The beverage supplying apparatus claim 8, wherein the controller includes
a processor, and
a non-transitory storage medium having program instructions stored thereon, execution of which by the processor causes the controller to control the touchable display and the beverage supplying apparatus for beverage dispensing.
